(19) United States
(12) Patent Application Publication
(10) Pub. No.: US 2025/0045175 A1
(43) Pub. Date: Feb. 6, 2025

(54) INTELLIGENT, SELF-LEARNING LOG CONFIGURATION GENERATION

(71) Applicant: INTERNATIONAL BUSINESS MACHINES CORPORATION, Armonk, NY (US)

(72) Inventors: Zhong Hui LIN, Dublin, OH (US); Harish BHARTI, Pune (IN); Hong Bing ZHANG, Beijing (CN)

(73) Assignee: INTERNATIONAL BUSINESS MACHINES CORPORATION, Armonk, NY (US)

(21) Appl. No.: 18/363,648

(22) Filed: Aug. 1, 2023

(51) Int. Cl. G06F 11/14

(52) U.S. Cl. CPC G06F 11/1471

(57) ABSTRACT

Various embodiments are provided herein for intelligent, self-learning log configuration generation for a corresponding application in a computing environment. A plurality of input data sources are examined to generate a log profile. The log profile is used to generate one or more cognitive log configurations. Those of a plurality of attributes and fields which are determined useful to be logged before a runtime operation are automatically retrieved. The plurality of attributes and fields are continuously optimized during the runtime operation using a feedback mechanism.

### BACKGROUND

The present invention relates in general to computing systems, and more particularly, to various embodiments for intelligent, self-learning log configuration generation in a computing environment.

### SUMMARY

According to an embodiment of the present invention, a method for intelligent, self-learning log configuration generation for a corresponding application in a computing environment, is provided. A plurality of input data sources is examined to generate a log profile. The log profile is used to generate one or more cognitive log configurations. Those of a plurality of attributes and fields which are determined used to be logged before a runtime operation are automatically retrieved. The plurality of attributes and fields are continuously optimized during the runtime operation using a feedback mechanism.

An embodiment includes a computer usable program product. The computer usable program product includes a computer-readable storage device, and program instructions stored on the storage device. The computer usable program product includes program instructions for implementing the aforementioned log generation in the computing environment.

An embodiment includes a computer system. The computer system includes a processor, a computer-readable memory, and a computer-readable storage device, and program instructions stored on the storage device for execution by the processor via the memory. In one embodiment, a portion of the computer system is adapted for implementing the aforementioned log generation, such as a specialized hardware device.

Thus, in addition to the foregoing exemplary method embodiments, other exemplary system and computer product embodiments are provided.

### BRIEF DESCRIPTION OF THE DRAWINGS

FIG. 1 is a block diagram depicting an exemplary cloud computing node according to an embodiment of the present invention.

FIG. 2 is a flow chart diagram depicting an exemplary method for conventionally setting log configurations, monitoring, and analyzing log generation according to the current state of the art, and an additional flow chart diagram depicting an additional exemplary method for intelligent, self-learning log configuration generation and analysis according to the mechanisms of the present invention.

FIG. 3 is a flow chart diagram of an additional exemplary method for intelligent, self-learning log configuration generation and analysis, again according to the mechanisms of the present invention.

FIG. 4 is a block diagram of additional exemplary functionality concerning various processes incurred during a self-learning log configuration generation operation, again according to an exemplary embodiment of the present invention.

FIG. 5 is a flow chart diagram depicting exemplary functionality incorporated into an input layer operation, according to the mechanisms of the illustrated embodiments.

FIG. 6 is an additional flow chart diagram depicting exemplary functionality incorporated into defining an application profile operation, again according to the mechanisms of the illustrated embodiments.

FIG. 7 is an additional flow chart diagram depicting exemplary functionality incorporated into generating an industry profile using an industry profile generator engine, using artificial intelligence (AI), again according to the mechanisms of the illustrated embodiments.

FIG. 8 is an additional flow chart diagram depicting exemplary functionality performed by an industry log setting engine, using artificial intelligence (AI), again according to the mechanisms of the illustrated embodiments.

FIG. 9 is an additional flow chart diagram depicting exemplary functionality performed by an application log setting engine, using artificial intelligence (AI), again according to the mechanisms of the illustrated embodiments.

FIG. 10 is an additional flow chart diagram depicting exemplary functionality incorporated into a log output layer operation, again according to the mechanisms of the illustrated embodiments.

FIG. 11 is an additional flow chart diagram depicting exemplary functionality performed by a log setting adjustment engine incorporating a feedback mechanism, again according to the mechanisms of the illustrated embodiments.

FIG. 12 is an additional flow chart diagram depicting an exemplary method for intelligent self-learning log configuration generation, according to an additional embodiment of the present invention.

### DETAILED DESCRIPTION OF THE DRAWINGS

Traditional error logging in computing environments, for purposes of identifying and resolving problems such as bugs (debugging), operational problems, runtime inefficiencies, and other issues, is typically a lengthy, data intensive, cumbersome and inefficient process. For example, when developers log messages for debugging purposes, the developer may not choose a correct field to log, such that user complaints can be properly addressed and traced.

After experiencing problems in debugging problem tickets, for example, a developer may end up logging a complete data payload. A typical default payload may consist of many contributions from a variety of contributors. A large data payload may not only cause problems with input/output (I/O) performance, but may have other attendant issues such as costly data storage, and pose difficulties for those searching the large data repository to find an analyze the right information.

For differing industry applications, depending on the applications, users, industry professionals and others involved, there is a variety of (correct) information to be logged for proper and efficient identification and analysis. Currently, developers often log all possible fields in order to debug, or alternatively are required to manually choose the particular field and then manually adjust fields. A need exists for a mechanism to appropriately log the correct fields, preferably automatically and intelligently, and thereby provide an efficient and cost-effective log generation solution without costing I/O performance in computing environments.

To address this aforementioned need, the mechanisms of the illustrated embodiments provide solutions for intelligent, self-learning log configuration generation as will be further described, following. These mechanisms utilize, in one exemplary embodiment, functionality such as integrated artificial intelligence (AI) learning operations, implement feedback mechanisms for improving log generation and other operations, and feature various functionality incorporated into various engines as will be described.

For example, in one exemplary embodiment, a wide variety of input data sources is examined to generate a so-called “log profile,” as will be further described. The log profile is used to generate one or more cognitive log configurations, again as will be described, following. Using the log profile, the correct attributes and fields that are determined (using, for example AI and other processing means) to be appropriately used to be logged before a runtime operation of the corresponding application are automatically and intelligently retrieved. Finally, the attributes and fields (among other aspects) may be continuously optimized during a subsequent runtime operation using a feedback operation.

In further embodiments, a log profiling framework is constructed to manage fine-grained aspects of one or more technical dimensions of the application aligned to a non-functional usage. The log profiling framework can also be configured to manage fine-grained aspects of one or more functional dimensions of the application aligned a business usage, as will be further described. The log profile framework may be continuously updated with deep learning functionality provided by artificial intelligence (AI) from, for example, industry-specific usage patterns and implementations experiences ingested from at least one of a number of diverse input sources.

In further embodiments a function-specific combination of correlation, regression and classification algorithms in combination with information derived from the log profile may be leveraged to implement an industry-specific interface for automated log generation for a specified function. A log setting combiner may be implemented in some embodiments, which incorporates those attributes and fields which are determined useful to be logged before a runtime operation to provide wide coverage for differing classifications of error types of the corresponding application. Finally, the cognitive logging configurations may be intelligently selected to be mapped to one of a variety of possible components, such as a transaction type, a failure rate, a code quality metric, and a predictive defect capability.

It should be noted that one or more calculations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

In general, as may be used herein, “optimize” may refer to and/or defined as “maximize,” “minimize,” “best,” or attain one or more specific targets, objectives, goals, or intentions. Optimize may also refer to maximizing a benefit to a user (e.g., maximize a trained machine learning scheduling agent benefit). Optimize may also refer to making the most effective or functional use of a situation, opportunity, or resource.

Additionally, optimizing need not refer to a best solution or result but may refer to a solution or result that “is good enough” for a particular application, for example. In some implementations, an objective is to suggest a “best” combination of operations, schedules, PE's, and/or machine learning models/machine learning pipelines, but there may be a variety of factors that may result in alternate suggestion of a combination of operations, schedules, PE's, and/or machine learning models/machine learning pipelines yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), static random access memory (SRAM), dynamic random access memory (DRAM), read-only memory (ROM), nonvolatile memory, erasable programmable read-only memory (EPROM or Flash memory), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

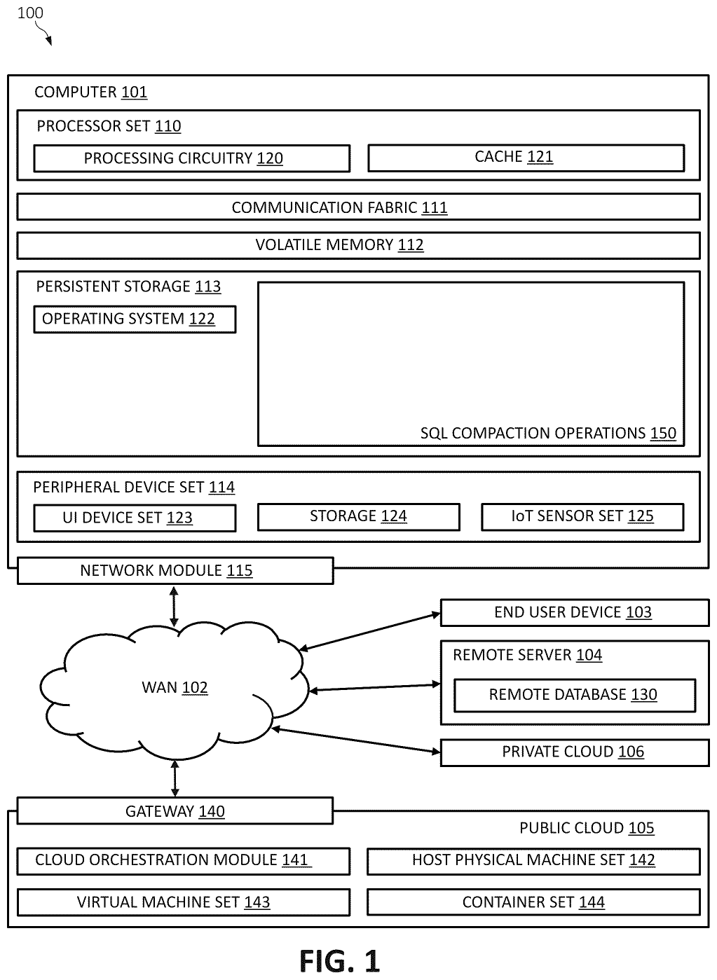

Turning now to FIG. 1, computing environment 100 contains an example of an environment for the execution of at least some of the computer code involved in performing the inventive methods, such as code for acceleration of inflight deployments by inflight deployment module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

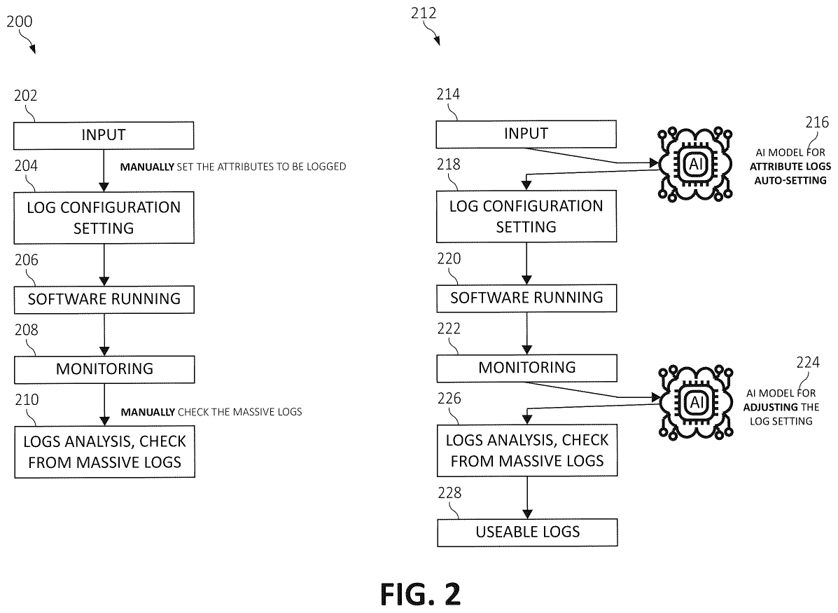

Turning now to FIG. 2, flow chart 200 depicts an exemplary method 200 for performing conventional log generation and analysis according to the present state of the art. Method 200 begins with input 202, where the attributes to be logged are manually set by the developer in log configuration setting 204. As the application runs in step 206, the system monitors the application in step 208, and based on the manually set log configuration, generates typically an enormous set of logs in step 210, which may or may not be relevant or useful to the developer. The developer manually analyzes the massive set of logs in step 210 and painstakingly sifts through the data to identify and analyze any appropriate logs.

Alternatively, method 212 depicts and describes in general, various aspects of the following illustrated embodiments, according to the mechanisms of the present invention. Method 212 begins in step 214 with the input of a wide variety of input data from a correspondingly wide variety of input sources. Using an AI model for auto-setting attribute logs in step 216, the method 212 automatically generates several log configuration settings in one or more log profiles in step 218. In step 220, the application continues a runtime operation as previously in step 206, but here in the monitoring phase in step 222, an AI model is implemented for adjusting one or more of the log configuration settings in step 224. Using one or more feedback mechanisms in step 226, various parameters or the log settings may be tuned during the runtime operation. As a result, a set of concise, usable logs are generated in step 228, in which the system may automatically identify for the developer and even provide some analysis functions.

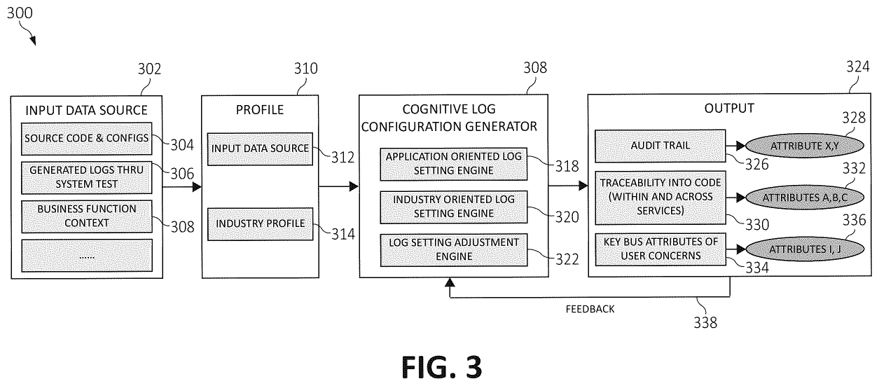

Turning now to FIG. 3, a block/flow diagram depicts an exemplary method 300 for intelligent, self-learning log generation incorporating additional functionality as specified, in another exemplary embodiment. Block 302 depicts the input data source 302, which as stated previously, may be drawn from a wide variety of input data sources, such as source code itself and related configuration settings 304, previously generated logs 306 through system test and other operations, and business function context 308 in various forms, which may vary widely according to the particular business function, related application, or other background information as one of ordinary skill in the art will appreciate.

In block 310, following, various profiles are created from the input data sources 302, including an application profile 312 and an associated industry profile 314. The generation and use of these profiles will be further described in detail, following. As one of ordinary skill in the art will appreciate, the application profile 312 relates to the corresponding application itself, and the industry profile 314 relates to the corresponding industry that the application finds itself.

Various information from the profiles 310 are then provided to a so-called “cognitive log configuration generator,” which uses the information in three (or more, depending on the embodiment) engines 318, 320, and 322 as shown. Application oriented log setting engine 318 develops log configuration settings based on application-specific information provided, for example, from the previously generated application profile 312. Industry-oriented log setting engine 320 develops log configuration settings based on industry-specific information provided, for example, from the previously generated industry profile 314. Finally, log setting adjustment engine 322 receives feedback 338 through a feedback mechanism to provide continuous adjustment to various log configuration settings.

The log configuration settings developed and generated by the cognitive log configuration generator 316 are provided to the output block 324, which, as depicted, incorporates an audit trail 326 for providing a log history for a subsequent audit, outputting, for example attribute (x,y) 328. Output block 324 also is depicted incorporating block 330, which provides traceability functionality into the code itself (and as one of ordinary skill in the art will appreciate, within and across various services), outputting attribute (a,b,c) 332, and block 334, incorporation key bus attributes of any user concerns 334, and outputting attributes (i,j) 336 as shown. Finally, as previously described, feedback mechanism 338 provides continuous feedback information from the output block 324 to the cognitive log configuration generator 318.

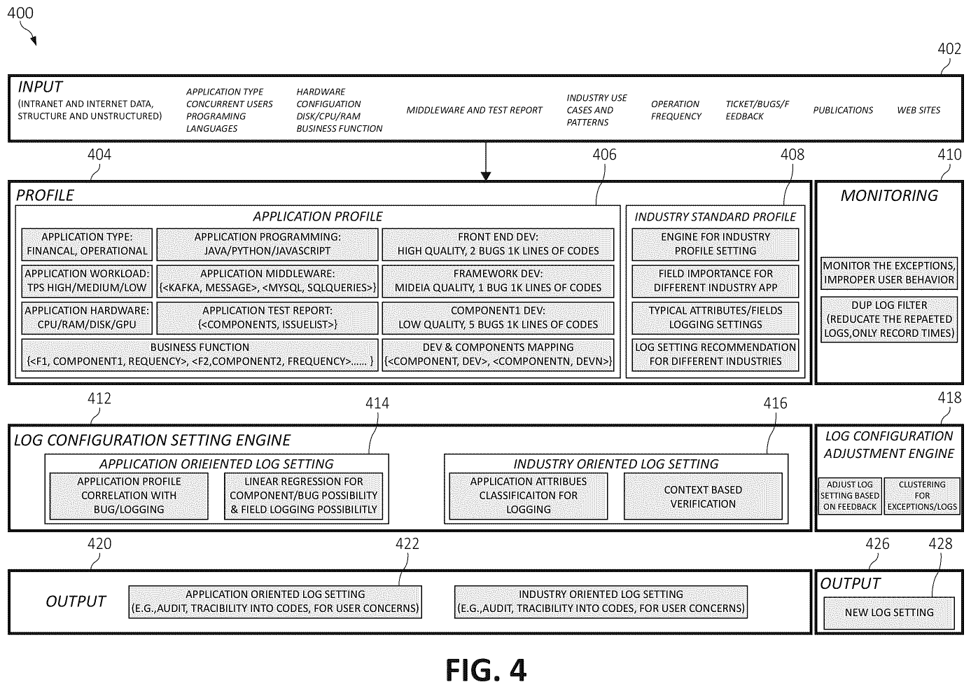

Turning now to FIG. 4, block diagram 400 depicts an exemplary, intelligent, self-learning log configuration generation system 400, incorporation further detailed functionality according to an embodiment of the present invention. System 400 depicts input block 402, which again incorporates a variety of input data sources, such as intranet and internet data, structured, and unstructured, application type, concurrent users, and programming languages, hardware configuration(s), specific disk(s)/CPU(s) and/or RAM, business function, industry use cases and patterns, operation frequency, previous tickets, bugs, or feedback, publications, and web site data.

Block 404 depicts profile information generated from the input data sources, including, and as previously mentioned, an application profile 406 and an industry standard profile 408. Application profile 406 examines various aspects such as (1) application type (whether financial, for example, or operational), (2) application workload (TPS high/medium/low), (3) application hardware (specific CPU/Ram/Disk/GPU), (4) application programming (e.g., Java/Python/Javascript), (5) application middleware (as depicted), (6) an application test report (as depicted), (7) business function (as depicted), and (8) various development attributes such as front end, framework, various component, and development and component mapping attributes as depicted.

In industry standard profile 408, various attributes and fields are considered, along with leveraging various engines for configuration log settings. This includes an engine for industry profile setting functionality, a weighted field importance for various industry applications, typical attributes/fields logging settings, and log setting recommendations for differing industries as depicted.

Adjacent to profile block 404, monitoring block 410 is depicted. Monitoring block 410 includes such monitoring functionality as monitoring exceptions and improper user behavior, and a duplicate log filter, which reduces repeated logs and only records times logged.

Log configuration setting engine block 412 is provided the various information from the profile block 404 to an application oriented log setting engine 414, which includes functionality for application profile correlation with bug/logging, and linear regression functionality for component/bug possibility and field logging possibility, as one of ordinary skill in the art will appreciate. Similarly engine 412 incorporates industry oriented log setting functionality 416, including application attributes classification for logging purposes, and context based verification functionality as depicted.

Adjacent to engine 412 is log configuration adjustment engine 416, which as previously described, receives feedback using a feedback mechanism to provide such functionality as the adjustment of log settings based on feedback, and clustering for exceptions and particular logs. Below engine 412 is output block 418, which incorporates application oriented log setting functionality 420 (such as audit, traceability into codes, and specific user concerns) and industry oriented log setting functionality 422 (such as again audit, traceability into codes, and specific user concerns). Finally, output 424 block incorporates new log setting functionality 426 as shown.

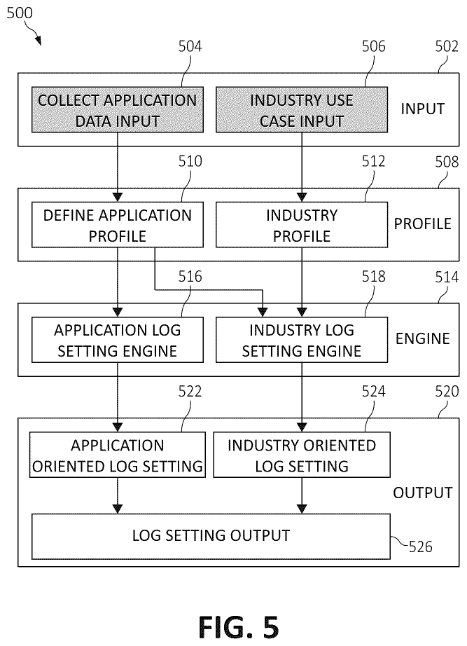

Turning now to FIG. 5, method 500 is a flow chart diagram depicting exemplary functionality performing intelligent, self-learning log generation according to one embodiment of the present invention. Method 500 focuses on the input layer 502, which involves collecting application data input 504 and industry use case input. Profile layer 508, incorporating functionality such as defining and generating an application profile 510 and defining and generating an industry profile 512, is shown. Similarly engine layer 514, incorporating such functionality as setting an application log 516 and setting an industry log and 518, is shown. Finally, output layer 520, incorporating application-oriented log setting functionality 522 and industry oriented log setting 524, generating log setting output 526 is depicted.

Returning to input later 502, the applicable data source is defined, and corresponding data is collected from the corresponding application. This may include such information as an application lifecycle (new or stable), concurrent user information, applicable programming languages, business functions, and corresponding hardware configuration(s) (e.g., disk/RAM/GPU configuration information). In addition, other information may be collected such as middleware, or test report information, and developers codes and bugs from, for example, a code hosting platform for version control and collaboration between developers.

In addition to the foregoing, an industry use case input by, for example, small and medium size business (SME) information may be defined. For example, a key transaction for a payment may be defined, or a key transaction for logistics and/or manufacturing may be defined. In addition, typical attributes for the particular industry application may be identified and defined. Finally, certain developer and/or user information such as developer and/or user feedback on the importance of the attributes for the particular industry application may be defined.

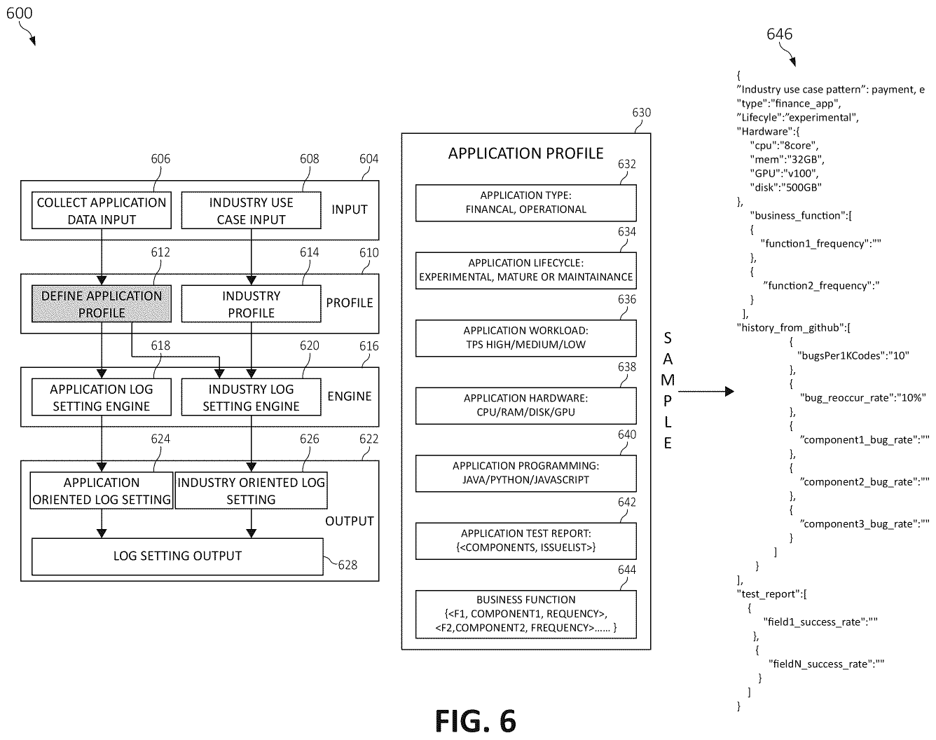

Turning now to FIG. 6, an exemplary method 602 depicting exemplary functionality for performing intelligent, self-learning log generation according to one embodiment of the present invention is shown, here focusing on the profile layer 610, and specifically, defining the application profile 612. Accordingly, the remaining functionality 604-628 in similar fashion to 502-526 in FIG. 5, previously, is also depicted in this example. The process of defining an application profile 612 incorporates the functionality show in block 630, which includes the following exemplary functionality. An application type (e.g., financial, operational) is defined in box 632. In box 634, the appropriate application lifecycle (e.g., experimental, mature, or maintenance is defined. In 636, the applicable application workload (e.g., TPS high/medium/low) is identified and defined. The appropriate application hardware (e.g., CPU/RAM/Disk/GPU information) is identified and defined in 638. The relevant application programming (e.g., Java/Python/Javascript) is identified and defined in 640. Information gleaned from sources such as an application test report is gathered and defined in 642. Finally, business function information is identified and defined in 644 as depicted. Sample code 646 making up a portion of an exemplary application profile 630 is depicted in 646 as shown.

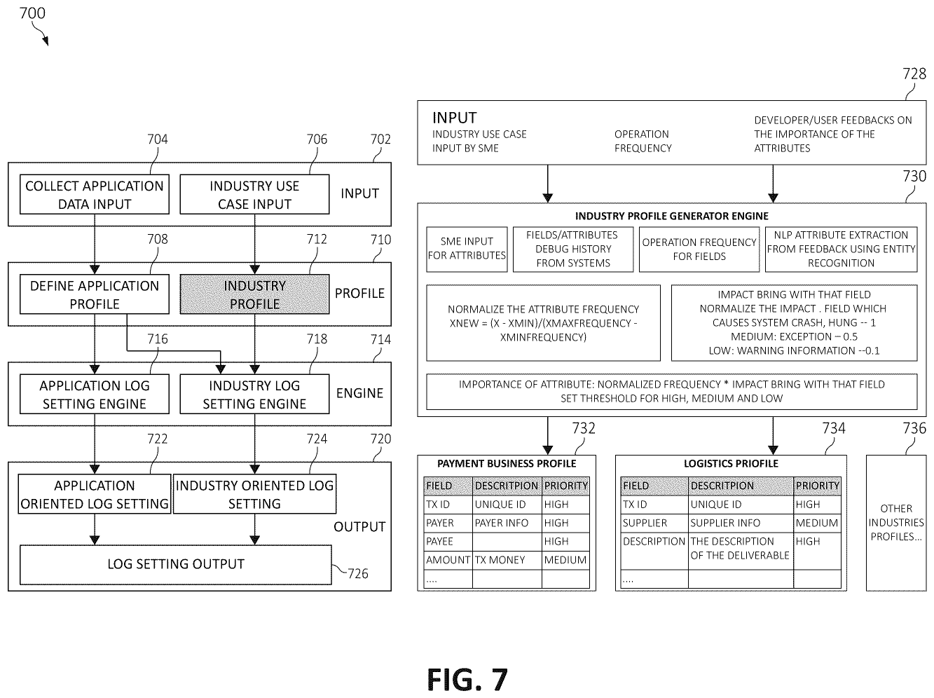

Turning now to FIG. 7, an exemplary method 700 depicting exemplary functionality for performing intelligent, self-learning log generation according to one embodiment of the present invention is shown, here focusing again on the profile layer 710, and specifically, defining the industry profile 712. Accordingly, the remaining functionality 702-726 in similar fashion to 502-526 in FIGS. 5, and 604-628 in FIG. 6, previously, is also depicted in this example. The process of defining an industry profile 712 first makes use of input layer 728 as shown, which performs such functionality as organizing an industry use case by SME from particular input data, determining an operation frequency from various input data, and inputting various developer/user feedbacks on, for example, the importance of the various selected attributes. Other input functionality examples have been described and are contemplated, and furthermore, one of ordinary skill in the art will appreciate the wide variety of input sources that may be considered in various embodiments.

As shown, industry profile generator engine 730 brings to bear certain of the industry-specific input information to generate the industry profile 712 as depicted. For example, such information as SME information for particular attributes, various fields/attributes debut history from particular systems, operation frequency for specific fields, and Natural Language Processing (NLP) attribute information that is extracted from various feedback using entity recognition.

Industry profile generator engine 730 also may perform certain tasks using various input data as previously described to in the process or determining a relative importance for a particular attribute, which may be helpful in determining the overall priority to which a particular log may be later examined and/or disposed, for example. In one embodiment, an attribute frequency metric may be normalized, as one of ordinary skill in the art will appreciate. In the same embodiment, an impact metric describing an impact made with a particular field is also normalized. Accordingly, the particular importance of a particular attribute is then defined as the product of the normalized attribute frequency metric and the normalized impact metric.

Boxes 732 and 734, following, depict exemplary listings of various fields, respective descriptions, and assigned priorities as a result of these operations previously described. For example, in box 732, a listing of fields for a specified payment business profile is depicted, assigning a Tx ID (Unique ID) as high priority. In box 734, a listing of fields for a specified logistics profile is depicted, showing, for example, that a description field (describing the deliverable) is assigned a corresponding low priority. Finally in box 736, other industry profile(s) are generated in a similar manner.

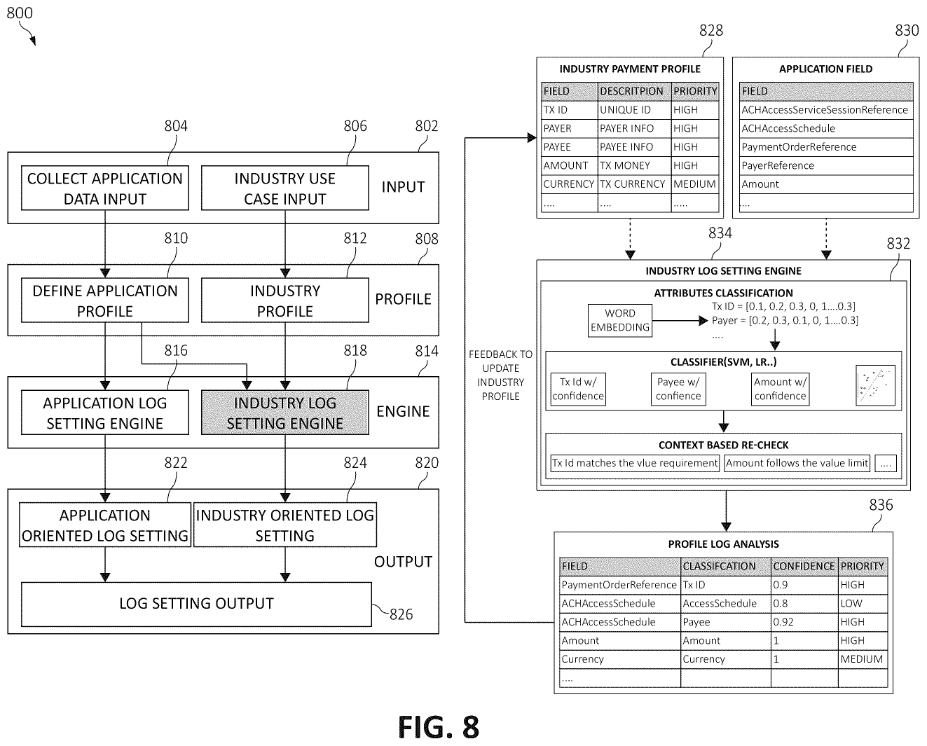

Turning now to FIG. 8, an exemplary method 800 depicting exemplary functionality for performing intelligent, self-learning log generation according to one embodiment of the present invention is shown, here focusing on the engine layer 814, and specifically, functionality associated with the industry log setting engine 818. Accordingly, the remaining functionality 802-826 in similar fashion to 502-526 in FIG. 5, 604-628 in FIGS. 6, and 702-726 in FIG. 7 previously, is also depicted in this example.

Functionality associated with exemplary operations of industry log setting engine 818 is further depicted as shown. Industry payment profile 828 as previously described in FIG. 7, and application field 830 are submitted to the industry log setting engine 818 as shown. The industry log setting engine 818, among other exemplary functionality, performs an attributes classification operation 832, that assigns classifiers to various fields and associated attributes as shown. Further, the industry log setting engine 818 performs a context based recheck operation to, for example, verify that various attributes match up, or follow various fields in a particular implementation.

The results of the analysis performed by engine 818 is shown as block 836 as profile log analysis 836. Profile log analysis contains various fields as indicated, respective classifications associated with the various fields, and an assigned/calculated confidence metric and associated priority. For example the “currency” field is associated with the “currency” classification, assigned a confidence value of one (1), and a “medium” priority. Finally in step 838, various feedback is provided to update the industry payment profile 828 as shown using a feedback mechanism. Other processing functionality associated with industry log setting engine 818 are contemplated, and one of ordinary skill in the art will appreciate the wide variety of industry-specific analysis that may be implemented by engine 818 in various embodiments.

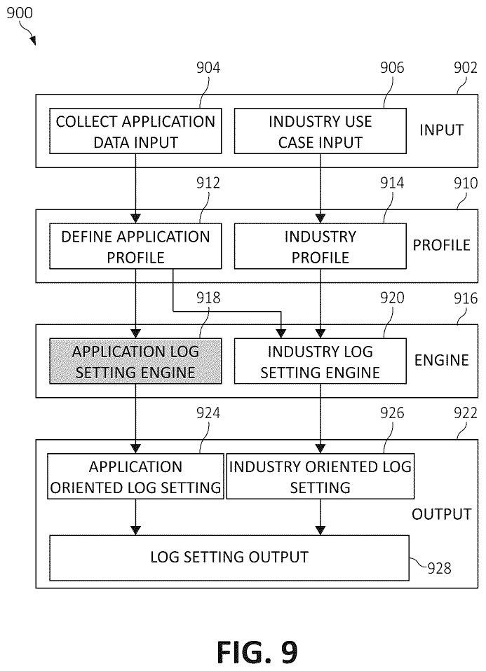

Turning now to FIG. 9, an exemplary method 900 depicting exemplary functionality for performing intelligent, self-learning log generation according to one embodiment of the present invention is shown, here focusing on the engine layer 910, and specifically, functionality associated with the application log setting engine 918. Accordingly, the remaining functionality 902-928 in similar fashion to 502-526 in FIG. 5, 604-628 in FIG. 6, 702-726 in FIGS. 7, and 802-826 in FIG. 8 previously, is also depicted in this example.

Application log setting engine 918, in one embodiment, examines various attributes, fields, or components, and using a variety of processing techniques such as specific algorithms, AI deep learning, or other functionality (such as various correlation, regression, and classification algorithms among other functionality), utilizes such metrics as bug rates, test bugs corelated with development, function operation frequency, or phase of a particular application to determine an issue possibility for a particular component. If the determined issue possibility for a particular component is high, then the application log setting engine 918 instructs the system to log the particular component/field. Furthermore, and as previously described, as a result of normalization operations, the application log setting engine may determine a particular impact metric of a component with a particular field that is used in conjunction with the issue possibility for a particular component to generate a specific priority metric for the component.

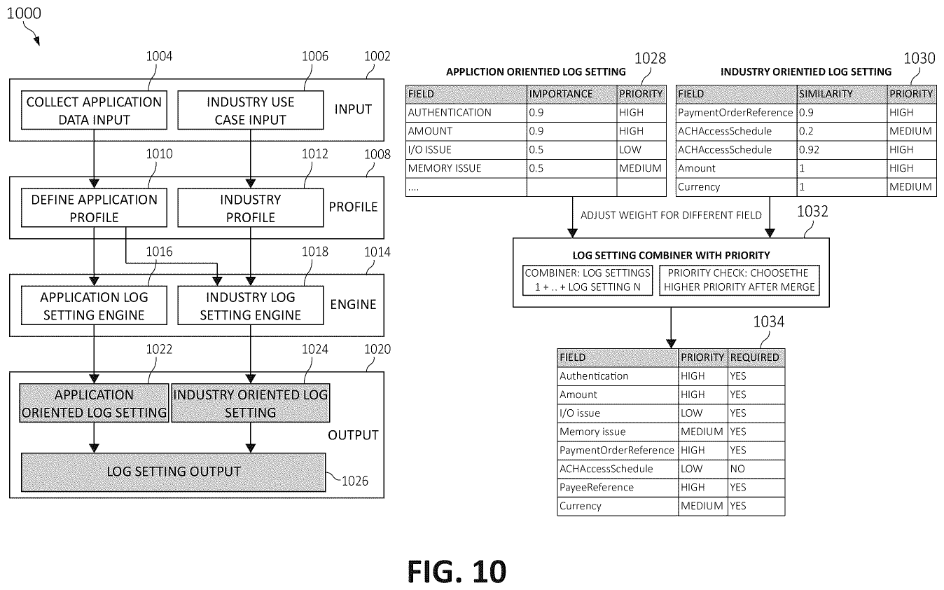

Turning now to FIG. 10, an exemplary method 1000 depicting exemplary functionality for performing intelligent, self-learning log generation according to one embodiment of the present invention is shown, here focusing on the output layer 1020, and specifically, functionality associated with application-oriented log setting 1022 and industry-oriented log setting 1024 in producing a log setting output 1026 as shown. Accordingly, the remaining functionality 1002-1026 in similar fashion to 502-526 in FIG. 5, 604-628 in FIG. 6, 702-726 in FIG. 7, 802-826 in FIGS. 8, and 902-928 in FIG. 9 previously, is also depicted in this example.

As previously indicated, application-oriented log setting engine1016 performs log setting functionality by using application-specific profile configuration information 1010 from the profile level 1008 as processed through the application log setting engine 1016. Similarly, the industry-oriented log setting engine 1018 processes industry-specific profile configuration information 1012 from the profile level 1008 through the industry log setting engine 1018 as shown.

Application-oriented log setting output 1022 then takes such application-specific log configuration setting information such as table 1028, which lists various associated application-specific fields with an assigned importance value and corresponding priority, while industry-oriented log setting output 1024 takes such industry-specific log configuration setting information such as table 1030, also listing various associated industry-specific fields with an assigned importance and corresponding priority, while adjusting various weights for differing fields, into a log setting combiner 1032 (retaining a priority value). The log setting combiner 1032 combines both application and industry-specific log configuration setting information using, for example, logarithmic functionality for ordering settings and performing a priority check to reorder settings according to higher priority after the merger between log setting information 1028 and 1030 as shown.

An exemplary output of log setting combiner 1032 is shown as table 1034, following. Both industry-specific and application-specific fields taken from tables 1028 and 1030 are combined with their appropriate priority. Furthermore, the log setting output 1026 determines whether the applicable field is required to be logged or not. For example, the “authentication” field shows a high priority and is logged by the system.

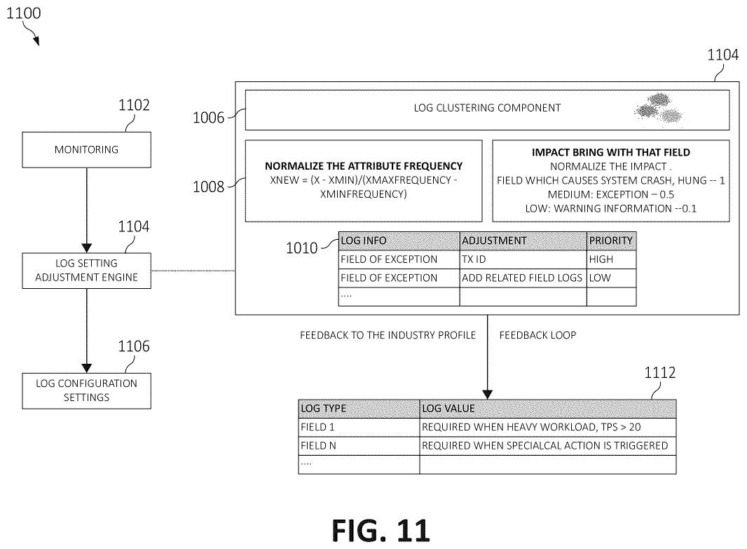

Turning now to FIG. 11, method 1100 depicts exemplary log setting adjustment functionality using a feedback mechanism, in accordance with the mechanisms of the present invention. In simple terms, the system monitors 1102 the application, before and during runtime as previously described. The log setting adjustment engine 1104 examines the current state of log profile information, the performance of the application and industry-specific log configuration setting engines, and output.

The log setting adjustment engine may, for example, implement the depicted functionality 1104 as shown in block 1104. A log clustering component 1106 may aggregate log information as monitored to identify various log behavior that may be previously, or presently defined. The functionality 1104 may perform such tasks as normalization to various attribute frequencies based on current data, and normalize the impact field with such data, again using techniques as previously described. This information as normalized may be summarized in a table of log information 1110 that may require adjustment of some kind. For example in a defined exception field, it is determined that a call stack should be added as a log configuration adjustment. This adjustment is assigned a high priority, and through the applicable feedback loop, is adjusted in the industry-specific profile as shown in table 1112.

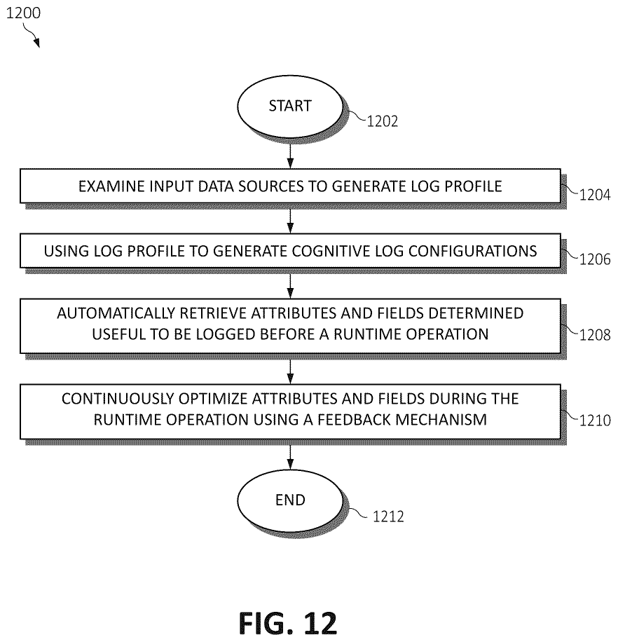

Turning now to FIG. 12, an exemplary method for intelligent, self-learning log configuration generation according to the mechanisms of the illustrated embodiments is depicted. Method 1200 begins (step 1202) with the examination of input data sources to generate a log profile (step 1204). The log profile is utilized to generate cognitive log configurations (step 1206. Attributes and fields determined useful to be logged before a runtime operation are automatically retrieved (Step 1208) The attributes and fields are continuously optimized during the runtime operation using a feedback mechanism (step 1210). The method 1200 then ends (step 1212).

The present invention may be a system, a method, and/or a computer program product. The computer program product may include a computer readable storage medium (or media) having computer readable program instructions thereon for causing a processor to carry out aspects of the present invention. for implementing multiple thread scenes in a computing environment virtualized metaverse, according to an embodiment of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The descriptions of the embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for intelligent, self-learning log configuration generation for a corresponding application, in a computing environment having one or more processor devices, comprising:
examining a plurality of input data sources to generate a log profile;
using the log profile to generate one or more cognitive log configurations; and
automatically retrieving those of a plurality of attributes and fields which are determined useful to be logged before a runtime operation, and continuously optimizing the plurality of attributes and fields during the runtime operation using a feedback mechanism.

2. The method of claim 1, wherein generating the log profile further includes building a log profiling framework to manage fine-grained aspects of one or more technical dimensions of the application aligned to a non-functional usage.

3. The method of claim 1, wherein generating the log profile further includes building a log profiling framework to manage fine-grained aspects of one or more functional dimensions of the application aligned a business usage.

4. The method of claim 1, wherein using the log profile further includes continuously learning from industry-specific usage patterns and implementations experiences ingested from at least one of a plurality of diverse input sources.

5. The method of claim 1, wherein using the log profile further includes implementing a function-specific combination of correlation, regression and classification algorithms in combination with information derived from the log profile to implement an industry-specific interface for automated log generation for the specified function.

6. The method of claim 1, further including implementing a log setting combiner, the log setting combiner incorporating those of the plurality of attributes and fields which are determined useful to be logged before a runtime operation to provide wide coverage for differing classifications of error types of the corresponding application.

7. The method of claim 1, further including intelligently selecting at least one of the cognitive logging configurations to be mapped to at least one of a transaction type, a failure rate, a code quality metric, and a predictive defect capability.

8. A system for intelligent, self-learning log configuration generation in a computing environment having one or more processor devices, comprising:
one or more computers with executable instructions that when executed cause the system to:
examine a plurality of input data sources to generate a log profile,
use the log profile to generate one or more cognitive log configurations, and
automatically retrieve those of a plurality of attributes and fields which are determined useful to be logged before a runtime operation, and continuously optimizing the plurality of attributes and fields during the runtime operation using a feedback mechanism.

9. The system of claim 8, wherein the executable instructions when executed cause the system to, pursuant to generating the log profile, build a log profiling framework to manage fine-grained aspects of one or more technical dimensions of the application aligned to a non-functional usage.

10. The system of claim 8, wherein the executable instructions when executed cause the system to, pursuant to generating the log profile, build a log profiling framework to manage fine-grained aspects of one or more functional dimensions of the application aligned a business usage.

11. The system of claim 8, wherein the executable instructions when executed cause the system to, pursuant to using the log profile, continuously learning from industry-specific usage patterns and implementations experiences ingested from at least one of a plurality of diverse input sources.

12. The system of claim 8, wherein the executable instructions when executed cause the system to, pursuant to using the log profile, implement a function-specific combination of correlation, regression and classification algorithms in combination with information derived from the log profile to implement an industry-specific interface for automated log generation for the specified function.

13. The system of claim 8, wherein the executable instructions when executed cause the system to implement a log setting combiner, the log setting combiner incorporating those of the plurality of attributes and fields which are determined useful to be logged before a runtime operation to provide wide coverage for differing classifications of error types of the corresponding application.

14. The system of claim 8, wherein the executable instructions when executed cause the system to intelligently select at least one of the cognitive logging configurations to be mapped to at least one of a transaction type, a failure rate, a code quality metric, and a predictive defect capability.

15. A computer program product intelligent, self-learning log configuration generation for a corresponding application, the computer program product comprising:
one or more computer readable storage media, and program instructions collectively stored on the one or more computer readable storage media, the program instruction comprising:
program instructions to examine a plurality of input data sources to generate a log profile,
program instructions to us the log profile to generate one or more cognitive log configurations, and
program instructions to automatically retrieve those of a plurality of attributes and fields which are determined useful to be logged before a runtime operation, and continuously optimizing the plurality of attributes and fields during the runtime operation using a feedback mechanism.

16. The computer program product of claim 15, further including program instructions to, pursuant to generating the log profile, build a log profiling framework to manage fine-grained aspects of one or more technical dimensions of the application aligned to a non-functional usage.

17. The computer program product of claim 15, further including program instructions to, pursuant to generating the log profile, build a log profiling framework to manage fine-grained aspects of one or more functional dimensions of the application aligned a business usage.

18. The computer program product of claim 15, further including program instructions to, pursuant to using the log profile, continuously learn from industry-specific usage patterns and implementations experiences ingested from at least one of a plurality of diverse input sources.

19. The computer program product of claim 15, further including program instructions to, pursuant to using the log profile, implement a function-specific combination of correlation, regression and classification algorithms in combination with information derived from the log profile to implement an industry-specific interface for automated log generation for the specified function.

20. The computer program product of claim 15, further including program instructions to perform at least one of:
implementing a log setting combiner, the log setting combiner incorporating those of the plurality of attributes and fields which are determined useful to be logged before a runtime operation to provide wide coverage for differing classifications of error types of the corresponding application, and
intelligently selecting at least one of the cognitive logging configurations to be mapped to at least one of a transaction type, a failure rate, a code quality metric, and a predictive defect capability.
